(19) United States
(12) Patent Application Publication
(10) Pub. No.: US 2021/0315002 A1
(43) Pub. Date: Oct. 7, 2021

(54) TERMINAL APPARATUS AND BASE STATION APPARATUS

(71) Applicant: SHARP KABUSHIKI KAISHA, Sakai City, Osaka (JP)

(72) Inventors: OSAMU NAKAMURA, Sakai City, Osaka (JP); YASUHIRO HAMAGUCHI, Sakai City, Osaka (JP)

(21) Appl. No.: 17/287,965

(22) PCT Filed: Oct. 25, 2019
(86) PCT No.: PCT/JP2019/041875

§ 371 Date: Apr. 22, 2021

(30) Foreign Application Priority Data
Oct. 31, 2018 (JP) 2018-205080

(51) Int. Cl. H04W 72/14; H04W 28/04

(52) U.S. Cl. CPC H04W 72/14; H04W 28/04

(57) ABSTRACT

In a case that a plurality of configured grants are configured, a base station apparatus can detect a signal efficiently. A plurality of transmission opportunities are produced by configuring values of a plurality of time offsets for the configured grant scheduling. Transmission with repeated slots is applied to each transmission opportunity, and a redundancy version is also configured for each repetition. In a case that a plurality of transmission patterns are generated through the plurality of time offsets, control is performed such that the redundancy versions are identical in a certain slot.

### TECHNICAL FIELD

The present invention relates to a terminal apparatus and a base station apparatus. This application claims priority based on JP 2018-205080 filed on Oct. 31, 2018, the contents of which are incorporated herein by reference.

### BACKGROUND ART

In Long Term Evolution (LTE) communication system specified by the Third Generation Partnership Project (3G-PP), dynamic scheduling in which Downlink Control Information (grant) (DCI) is notified from a base station apparatus to a terminal apparatus and data is transmitted according to the notified DCI has been specified. In the dynamic scheduling, in a case that one piece of DCI is received, a single transmission operation is performed. On the other hand, in addition to dynamic scheduling, a Semi-Persistent Scheduling (SPS) for allocating radio resources periodically has been specified. In SPS, even in a case that one piece of DCI is received, radio resources are periodically allocated, so a plurality of data transmission operations can be performed.

Currently, the 3GPP has standardized the 5th generation mobile communication (New Radio or NR) with use cases of enhanced Mobile Broad Band (eMBB), Ultra-Reliable and Low Latency Communications (URLLC), massive Machine-Type Communications (mMTC). In NR Rel-15, Configured Scheduling (CS) that is an extension of SPS of LTE has been standardized. In CS, transmission with repeated slots is possible and reliability of transmission can be improved.

The 3GPP has been working for standardization in Release 16 to achieve even higher reliability (a packet reception success rate of 99.9999%) and low latency (a delay from 0.5 ms to 1 ms). (NPLs 2 and 3)

### CITATION LIST

### Non Patent Literature

NPL 1: 3GPP TS38.211, V15.2.0. “Physical channels and modulation (Release 15)”.

NPL 2: Huawei, HiSilicon, Nokia, Nokia Shanghai Bell, “SID on Physical Layer Enhancements for NR URLLC”, RP-181477.

NPL 3: Huawei, HiSilicon, “Enhanced UL configured grant transmissions”, R1-1808100.

### SUMMARY OF INVENTION

### Technical Problem

Release 16 is intended to improve reliability and reduce latency. Increasing transmission opportunities by providing a plurality of configurations as a configuration for CS has been discussed. However, details including priority in the case that a plurality of configurations are present have not been fully discussed. On the other hand, in order to perform a plurality of CS configurations, it is necessary to specify a control signal between a terminal apparatus and a base station apparatus and transmit the control signal.

An aspect of the present invention has been made in view of these circumstances, and an objective of the present invention is to provide a control method in a case that a plurality of CS configurations are present.

### Solution to Problem

To solve the above-mentioned problem, a base station apparatus, a terminal apparatus, and a communication method according to an aspect of the present invention are configured as follows.

(1) An aspect of the present invention is a base station apparatus for communicating with a terminal apparatus by using configured grant scheduling, the base station apparatus including a controller configured to configure values of a plurality of time offsets for the configured grant scheduling, and a higher layer processing unit configured to, for the configured grant scheduling, configure a redundancy version sequence and configure the number of repetitions of the redundancy version sequence to a value greater than one, in which the controller configures the values of the plurality of time offsets based on the redundancy version sequence.

(2) According to an aspect of the present invention, in a case that the controller is allowed to perform transmission using a plurality of transmission methods in a predetermined slot through the plurality of time offsets, the controller may perform configuration to use an identical redundancy version in the predetermined slot.

(3) According to an aspect of the present invention, configuration may be performed such that demodulation reference signal sequences are different in the predetermined slot through the plurality of time offsets.

(4) According to an aspect of the present invention, configuration may be performed such that scrambling operations are different in the predetermined slot through the plurality of time offsets.

(5) An aspect of the present invention is a terminal apparatus for communicating with a base station apparatus by using configured grant scheduling, the terminal apparatus including a controller configured to configure values of a plurality of time offsets for the configured grant scheduling, and a higher layer processing unit configured to configure a redundancy version sequence of the configured grant scheduling and configure the number of repetitions to a value greater than one, in which the controller configures the values of the plurality of time offsets based on the redundancy version sequence.

### Advantageous Effects of Invention

According to one or more aspects of the present invention, a base station apparatus and a terminal apparatus can perform a plurality of CS configurations.

### BRIEF DESCRIPTION OF DRAWINGS

FIG. 1 is a diagram illustrating a configuration example of a communication system 1 according to a first embodiment.

FIG. 2 is a diagram illustrating a configuration example of a base station apparatus according to the first embodiment.

FIG. 3 is a diagram illustrating a configuration example of a terminal apparatus according to the first embodiment.

FIG. 4 is a diagram illustrating transmission opportunities in a case that a plurality of time offsets are configured in a case of RV={0, 3, 0, 3} according to the first embodiment.

FIG. 5 is a diagram illustrating another example of transmission opportunities in a case that a plurality of time offsets are configured in a case of RV={0, 3, 0, 3} according to the first embodiment.

FIG. 6 is a diagram illustrating transmission opportunities in a case that a plurality of time offsets are configured in a case of RV={2, 3, 1} according to the first embodiment.

FIG. 7 is a diagram illustrating another example of transmission opportunities in a case that a plurality of time offsets are configured in a case of RV={0, 2, 3, 1} according to the first embodiment.

FIG. 8 is a diagram illustrating transmission opportunities in a case that a plurality of time offsets are configured in a case that slot hopping according to the first embodiment is applied.

### DESCRIPTION OF EMBODIMENTS

A communication system according to the present embodiment includes a base station apparatus (a cell, a small cell, a serving cell, a component carrier, an eNodeB, a Home eNodeB, or a gNodeB) and a terminal apparatus (a terminal, a mobile terminal, or User Equipment (UE)). In the communication system, in a case of downlink, the base station apparatus serves as a transmitting apparatus (a transmission point, a transmit antenna group, a transmit antenna port group, or a Tx/Rx Point (TRP)), and the terminal apparatus serves as a receiving apparatus (a reception point, a reception terminal, a receive antenna group, or a receive antenna port group). In a case of uplink, the base station apparatus serves as a receiving apparatus, and the terminal apparatus serves as a transmitting apparatus. The communication system is also applicable to Device-to-Device or sidelink (D2D) communication, In this case, the terminal apparatus serves as both a transmitting apparatus and a receiving apparatus.

The communication system is not limited to what is limited to data communication between the terminal apparatus and the base station apparatus with human intervention. That is, the communication system can also be applied to a form of data communication that does not need human intervention, such as Machine Type Communication (MTC), Machine-to-Machine (M2M) Communication, communication for Internet of Things (IoT), or Narrow Band-IoT (NB-IoT) (hereinafter referred to as MTC). In this case, the terminal apparatus serves as an MTC terminal. The communication system can use, in the uplink and the downlink, a multi-carrier transmission scheme, such as a Cyclic Prefix-Orthogonal Frequency Division Multiplexing (CP-OFDM). In a case that a higher layer parameter for Transform precoder is configured in uplink, the communication system uses a transmission scheme such as a Discrete Fourier Transform Spread-Orthogonal Frequency Division Multiplexing (DFTS-OFDM, also referred to as SC-FDMA) to which Transform preceding is applied, in other words, to which a DFT is applied. Note that, although a case that an OFDM transmission scheme is used in uplink and downlink will be described below, it is not limited thereto, and other transmission schemes may be applied.

The base station apparatus and the terminal apparatus according to the present embodiment can communicate in a frequency band for which an approval of use (license) has been obtained from a country or region where a radio operator provides services, that is, a so-called licensed band, and/or in a frequency band for which no approval of use (license) from the country or region is required, that is, a so-called unlicensed band.

According to the present embodiment, “X/Y” includes the meaning of “X or Y”. According to the present embodiment, “X/Y” includes the meaning of “X and Y”. According to the present embodiment, “X/Y” includes the meaning of “X and/or Y”.

### First Embodiment

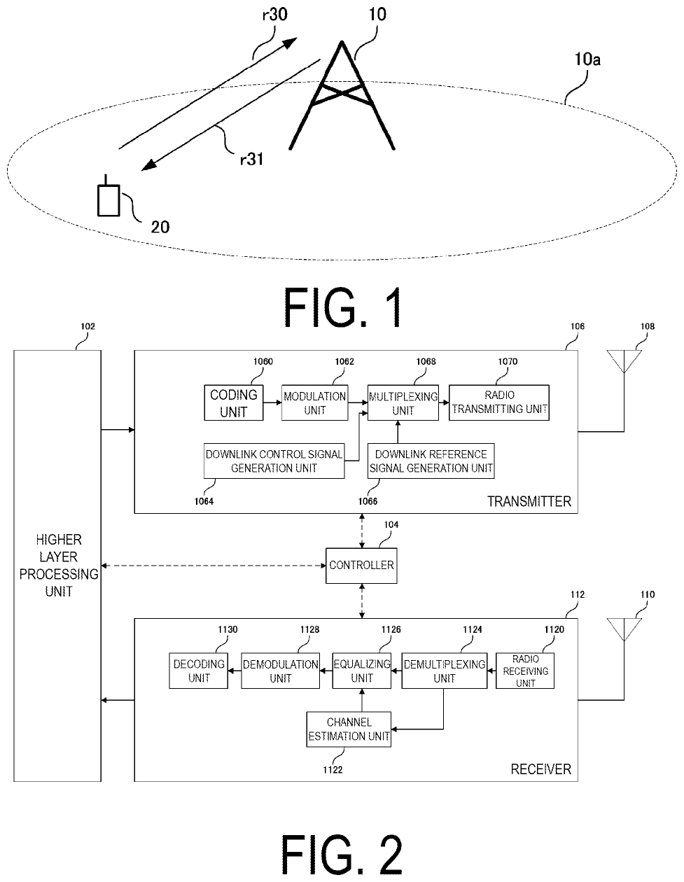

FIG. 1 is a diagram illustrating a configuration example of a communication system 1 according to the present embodiment. The communication system 1 according to the present embodiment includes a base station apparatus 10 and a terminal apparatus 20. A coverage 10a is a range in which the base station apparatus 10 can connect to (communicate with) the terminal apparatus 20 (a communication area which is also referred to as a cell). Note that the base station apparatus 10 can accommodate a plurality of terminal apparatuses 20 in the coverage 10a.

In FIG. 1, uplink radio communication r30 includes at least the following uplink physical channels. The uplink physical channels are used to transmit information output from a higher layer.
physical uplink control channel (PUCCH)
physical uplink shared channel (PUSCH)
physical random access channel (PRACH)

The PUCCH is a physical channel that is used to transmit Uplink Control Information (UCI). The Uplink Control Information includes a positive acknowledgement (ACK)/a Negative acknowledgement (NACK) for downlink data. Here, the downlink data indicates a Downlink transport block, a Medium Access Control Protocol Data Unit (MAC PDU), a Downlink-Shared Channel (DL-SCH), a Physical Downlink Shared Channel (PDSCH), or the like. The ACK/HACK is also referred to as a Hybrid Automatic Repeat request ACKnowledgement (HARQ-ACK), a HARQ feedback, a HARQ response, or a signal indicating HARQ control information or transmission confirmation.

An NR supports at least five formats including PUCCH format 0, PUCCH format 1, PUCCH format 2, PUCCH format 3, and PUCCH format 4. PUCCH format 0 and PUCCH format 2 include one or two OFDM symbols, and the other PUCCH formats include four to 14 OFDM symbols. In addition, the bandwidth of PUCCH format 0 and PUCCH format 1 includes 12 subcarriers. In addition, in PUCCH format 0, a 1-bit (or 2-bit) ACK/NACK is transmitted in resource elements of 12 subcarriers and one OFDM symbol (or two OFDM symbols).

The uplink control information includes a Scheduling Request (SR) used to request a PUSCH (Uplink-Shared Channel (UL-SCH)) resource for initial transmission. The scheduling request indicates that the UL-SCH resource for initial transmission is requested.

The uplink control information includes downlink Channel State Information (CSI). The downlink channel state information includes a Rank Indicator (RI) indicating a preferable spatial multiplexing order (the number of layers), a Precoding Indicator (PMI) indicating a preferable precoder, a Channel Quality Indicator (CQI) specifying a preferable transmission rate, and the like. The PMI indicates a codebook determined by the terminal apparatus. The codebook is associated with preceding of a physical downlink shared channel.

In NR, a higher layer parameter RI restriction can be configured. There are a plurality of configuration parameters for the RI restriction, one of which is a type 1 single panel RI restriction and includes eight bits. The type 1 single panel RI restriction which is a bitmap parameter forms bit sequences r₇ . . . , r₂, and r₁. Here, r₇ is a Most Significant Bit (MSB), and r₀ is a Least Significant Bit (LSB). In a case that r₇ is zero (i is 0, 1 . . . , or 7), PMI and RI reporting corresponding to the precoder associated with the i+1 layers are not acceptable. The RI restriction includes type 1 multi panel RI restriction in addition to the type 1 single panel RI restriction, and the type 1 multi panel RI restriction includes four bits. The type 1 multi panel RI restriction which is a bitmap parameter forms bit sequences r₄, r₃, r₂, and r₁. Here, r₄ is the MSB, and r₀ is the LSB. In a case that rᵢ is zero (i is 0, 1, 2, or 3), PMI and RI reporting corresponding to the precoder associated with the i+1 layers are not acceptable.

The CQI can use an index (CQI index) indicative of a preferable modulation scheme (for example, QPSK, 16 QAM, 64 QAM, 256 QAMAM, or the like), coding rate, and frequency efficiency in a predetermined band, The terminal apparatus selects, from a CQI table, a CQI index at which a transport block of the PDSCH is likely to be received with a block error probability (BLER) not exceeding 0.1. However, in a case that a predetermined CQI table is configured by higher layer signaling, a CQI index at which transport blocks are likely to be received with a BLER not exceeding 0.00001 is selected from the CQI table.

The PUSCH is a physical channel used to transmit uplink data (an Uplink Transport Block, an Uplink-Shared Channel (UL-SCH)), and CP-OFDM or DFT-S-OFDM is applied thereto as a transmission scheme. The PUSCH may be used to transmit the HARQ-ACK in response to the downlink data and/or the channel state information along with the uplink data. The PUSCH may be used to transmit only the channel state information. The PUSCH may be used to transmit only the HARQ-ACK and the channel state information.

The PUSCH is used to transmit Radio Resource Control (RRC) signaling. The RRC signaling is also referred to as an RRC message/RRC layer information/an RRC layer signal/an RRC layer parameter/an RRC information element. The RRC signaling is information/a signal processed in a radio resource control layer. The RRC signaling transmitted from the base station apparatus may be signaling shared by a plurality of terminal apparatuses in a cell. The RRC signaling transmitted from the base station apparatus may be signaling dedicated to a certain terminal apparatus (also referred to as dedicated signaling). In other words, information specific to a user equipment (unique to a user equipment) is transmitted using signaling dedicated to a certain terminal apparatus. The RRC message can include UE Capability of the terminal apparatus. The UE Capability is information indicating a function supported by the terminal apparatus.

The PUSCH is used to transmit a Medium Access Control Element (MAC CE). The MAC CE is information/a signal processed (transmitted) in a Medium Access Control layer. For example, a power headroom may be included in the MAC CE and may be reported via the physical uplink shared channel. In other words, the field of the MAC CE is used to indicate a level of the power headroom. The uplink data can include the RRC message and the MAC CE. The RRC signaling and/or the MAC CE are also referred to as a higher layer signal (higher layer signaling). The RRC signaling and/or the MAC CE are included in a transport block.

The PRACH is used to transmit a preamble used for random access. The PRACH is used to transmit a random access preamble. The PRACH is used to indicate an initial connection establishment procedure, a handover procedure, a connection re-establishment procedure, synchronization (timing adjustment) of uplink transmission, and a request for PUSCH (UL-SCH) resources.

In uplink radio communication, an Uplink Reference Signal (ULRS) is used as an uplink physical signal. The Uplink Reference Signal includes a Demodulation Reference Signal (DMRS) and a Sounding Reference Signal (SRS). The DMRS is associated with transmission of the physical uplink shared channel/physical uplink control channel. For example, the base station apparatus 10 uses the Demodulation Reference Signal to perform channel estimation/channel compensation in a case that the physical uplink shared channel/the physical uplink control channel are demodulated.

The SRS is not associated with transmission of the physical uplink shared channel/the physical uplink control channel. The base station apparatus 10 uses the SRS to measure an uplink channel state (CSI Measurement).

In FIG. 1, at least the following downlink physical channels are used in radio communication of downlink r31. The downlink physical channels are used to transmit information output from the higher layer.
physical broadcast channel (PBCH)
physical downlink control channel (PDCCH)
physical downlink shared channel (PDSCH)

The PBCH is used to broadcast a Master Information Block (MIB, a Broadcast Channel (BCH)) that is used commonly by the terminal apparatuses. The MIB is one piece of system information. For example, the MIB includes a downlink transmission bandwidth configuration and a System Frame number (SFN). The MIB may include information indicating at least some of a slot number, a subframe number, and a radio frame number in which a PBCH is transmitted.

The PDCCH is used to transmit downlink control information (DCI). For the downlink control information, a plurality of formats (also referred to as DCI formats) based on applications are defined. The DCI format may be defined based on the type and the number of bits of the DCI included in a single DCI format. Each format is used according to applications. The downlink control information includes control information for downlink data transmission and control information for uplink data transmission. The DCI format for downlink data transmission is also referred to as downlink assignment (or downlink grant). The DCI format for uplink data transmission is also referred to as uplink grant (or uplink assignment).

A single downlink assignment is used for scheduling of a single PDSCH in a single serving cell. The downlink grant may be used for at least scheduling of the PDSCH within the same slot as the slot in which the downlink grant has been transmitted. The downlink assignment includes downlink control information, such as frequency domain resource allocation and time domain resource allocation for the PDSCH, a Modulation and Coding Scheme (MCS) for the PDSCH, a NEW Data Indicator (NDI) indicating initial transmission or re-transmission, information indicating a HARQ process number in downlink, and a Redundancy version indicating an amount of redundancy added to the codeword during error correction coding. The codeword is data that has undergone error correction coding. The downlink assignment may include a Transmission Power Control (TPC) command for the PUCCH and a TPC command for the PUSCH. The uplink grant may include a Repetition number indicating the number of repetitive transmission operations of the PUSCH. Note that the DCI format for each downlink data transmission operation includes information (field) required for the application of the above-described information.

A single uplink grant is used to notify the terminal apparatus of scheduling of a single PUSCH in a single serving cell. The uplink grant includes uplink control information, such as information on the resource block allocation for transmission of the PUSCH (resource block allocation and hopping resource allocation), time domain resource allocation, information on the MCS of the PUSCH (MCS/Redundancy version), information on a DMRS port, information on re-transmission of the PUSCH, a TPC command for the PUSCH, and a request for downlink Channel State Information (CSI) (CSI request). The uplink grant may include information indicating a HARQ process number in uplink, a Transmission Power Control (TPC) command for the PUCCH, and a TPC command for the PUSCH. Note that the DCI format for transmission of each piece of uplink data includes information (fields) required for the application of the above-described information.

An OFDM symbol number (position) for transmitting a DMRS symbol is given in a signaling period between the beginning OFDM symbol of the slot and the last OFDM symbol of the PUSCH resource scheduled in the slot in a case of PUSCH mapping type A with no application of frequency hopping. In a case of PUSCH mapping type B with no application of frequency hopping, the OFDM symbol number is given in a scheduled PUSCH resource period. In a case that frequency hopping is applied, the OFDM symbol number is given in a period per hop. For the PUSCH mapping type A, only in a case that a higher layer parameter indicating the position of the leading DMRS is 2, a case that a higher layer parameter indicating a supplemental DMRS number is 3 is supported. Furthermore, for the PUSCH mapping type A, four symbol periods are applicable only in a case that the higher layer parameter indicating the position of the leading DMRS is 2.

The PDCCH is generated by adding a Cyclic Redundancy Check (CRC) to the downlink control information. In the PDCCH, CRC parity bits are scrambled using a predetermined identity (also referred to as an exclusive OR operation or a mask). The parity bits are scrambled with a Cell-Radio Network Temporary Identifier (C-RNTI), a Configured Scheduling (CS)-RNTI, a Temporary C-RNTI, a Paging (P)-RNTI, a System Information (SI)-RNTI, or a Random Access (RA)-RNTI. The C-RNTI and the CS-RNTI are identities for identifying a terminal apparatus within a cell. The Temporary C-RNTI is an identity for identifying the terminal apparatus that has transmitted the random access preamble during a contention based random access procedure. The C-RNTI and the Temporary C-RNTI are used to control PDSCH transmission in a single subframe or PUSCH transmission. The CS-RNTI is used to periodically allocate resources for the PDCCH or the PUSCH. Here, the PDCCH (DCI format) scrambled with the CS-RNTI is used to activate or deactivate the CS type 2. On the other hand, control information (MCS, radio resource allocation, and the like) included in the PDCCH scrambled with the CS-RNTI in CS type 1 is included in a higher layer parameter for CS, and the CS is activated (configured) by the higher layer parameter. The P-RNTI is used to transmit a paging message (Paging Channel (PCH)). The SI-RNTI is used to transmit an SIB, and the RA-RNTI is used to transmit a random access response (a message 2 in a random access procedure).

The PDSCH is used to transmit downlink data (a downlink transport block or DL-SCH). The PDSCH is used to transmit a system information message (also referred to as a System Information Block (SIB)). Some or all of SIBs can be included in the RRC message.

The PDSCH is used to transmit the RRC signaling. The RRC signaling transmitted from the base station apparatus may be common for the plurality of terminal apparatuses in the cell (unique to the cell). That is, information common for user equipments in the cell is transmitted using the RRC signaling unique to the cell. The RRC signaling transmitted from the base station apparatus may be a message dedicated to a certain terminal apparatus (also referred to as dedicated signaling). In other words, information specific to a user equipment (unique to a user equipment) is transmitted by using a message dedicated to a certain terminal apparatus.

The PDSCH is used to transmit a MAC CE. The RRC signaling and/or the MAC CE is also referred to as a higher layer signal (higher layer signaling). A PMCH is used to transmit multicast data (Multicast Channel (MCH)).

In the downlink radio communication of FIG. 1, a Synchronization signal (SS) and a Downlink Reference Signal (DLRS) are used as downlink physical signals. Although the downlink physical signals are not used to transmit information output from the higher layer, the downlink physical signals are used by the physical layer.

The synchronization signal is used for the terminal apparatus to take synchronization of the downlink in the frequency domain and the time domain. The downlink reference signal is used for the terminal apparatus to perform the channel estimation/channel compensation on the downlink physical channel. For example, the downlink reference signal is used to demodulate the PBCH, the PDSCH, and the PDCCH. The downlink reference signal can be used by the terminal apparatus to measure a downlink channel state (CSI measurement).

The downlink physical channel and the downlink physical signal are also collectively referred to as a downlink signal. In addition, the uplink physical channel and the uplink physical signal are also collectively referred to as an uplink signal. In addition, the downlink physical channel and the uplink physical channel arc also collectively referred to as a physical channel. In addition, the downlink physical signal and the uplink physical signal are also collectively referred to as a physical signal.

The BCH, the UL-SCH, and the DL-SCH are transport channels. Channels used in the MAC layer are referred to as the transport channels. The unit of transport channels used in the MAC layer is also referred to as a Transport Block (TB) or a MAC Protocol Data Unit (PDU). The transport block is the unit of data that the MAC layer delivers to the physical layer. In the physical layer, the transport block is mapped to a codeword, and coding processing and the like are performed for each codeword.

FIG. 2 is a schematic lock diagram of a configuration of the base station apparatus 10 according to the present embodiment. The base station apparatus 10 includes a higher layer processing unit (higher layer processing step) 102, a controller (control step) 104, a transmitter (transmitting step) 106, a transmit antenna 108, a receive antenna 110, and a receiver (receiving step) 112. The transmitter 106 generates a physical downlink channel in accordance with a logical channel input from the higher layer processing unit 102. The transmitter 106 includes a coding unit (coding step) 1060, a modulation unit (modulation step) 1062, a downlink control signal generation unit (downlink control signal generation step) 1064, a downlink reference signal generation unit (downlink reference signal generation step) 1066, a multiplexing unit (multiplexing step) 1068, and a radio transmitting unit (radio transmitting step) 1070. The receiver 112 detects (demodulates, decodes, or the like) a physical uplink channel and inputs the content to the higher layer processing unit 102. The receiver 112 is includes a radio receiving unit (radio receiving step) 1120, a channel estimation unit (channel estimation step) 1122, a demultiplexing unit (demultiplexing step) 1124, an equalizing unit (equalizing step) 1126, a demodulation unit (demodulation step) 1128, and a decoding unit (decoding step) 1130.

The higher layer processing unit 102 processes a higher layer than a physical layer such as a Medium Access Control (MAC) layer, a Packet Data Convergence Protocol (PDCP) layer, a Radio Link Control (RLC) layer, and a Radio Resource Control (RRC) layer. The higher layer processing unit 102 generates information required to control the transmitter 106 and the receiver 112, and outputs the resultant information to the controller 104. The higher layer processing unit 102 outputs downlink data (such as DL-SCH), system information (MIB or SIB), and the like to the transmitter 106. Note that DMRS structure information may be notified to the terminal apparatus by using the system information (MIB or SIB), instead of being notified using a higher layer of RRC, or the like.

The higher layer processing unit 102 generates, or acquires from a higher node, the system information (a part of the MIB or the SIB) to be broadcast. The higher layer processing unit 102 outputs the system information to be broadcast to the transmitter 106 as BCH/DL-SCH. The MIB is allocated to the PBCH in the transmitter 106. The SIB is allocated to the PDSCH in the transmitter 106. The higher layer processing unit 102 generates, or acquires from the higher node, the system information (SIB) unique to the terminal apparatus. The SIB is allocated to the PDSCH in the transmitter 106.

The higher layer processing unit 102 configures various RNTIs for each terminal apparatus, The RNTI is used for encryption (scrambling) of the PDCCH, the PDSCH, and the like. The higher layer processing unit 102 outputs the RNTI to the controller 104/the transmitter 106/the receiver 112.

In a case that downlink data (transport block, DL-SCH) mapped to the PDSCH, the system information specific to the terminal apparatus (System Information Block or SIB), the RRC message, the MAC CE, and DMRS structure information are not notified by using the system information such as the SIB and the MIB, or the DCI, the higher layer processing unit 102 generates, or acquires from a higher node, the DMRS structure information or the like, and then outputs the information to the transmitter 106. The higher layer processing unit 102 manages various kinds of configuration information of the terminal apparatus 20. Note that a part of the function of the radio resource control may be performed in the MAC layer or the physical layer.

The higher layer processing unit 102 receives information on the terminal apparatus, such as the function supported by the terminal apparatus (UE capability), from the terminal apparatus 20 (via the receiver 112). The terminal apparatus 20 transmits its own function to the base station apparatus 10 using a higher layer signal (RRC signaling). The information on the terminal apparatus includes information indicating whether the terminal apparatus supports a predetermined function or information indicating that the terminal apparatus has completed implementation and testing of the predetermined function. The information indicating whether the terminal apparatus supports the predetermined function includes information indicating whether the terminal apparatus has completed implementation and testing of the predetermined function.

In a case that the terminal apparatus supports the predetermined function, the terminal apparatus transmits information (parameter) indicating whether the terminal apparatus supports the predetermined function. In a case that the terminal apparatus does not support the predetermined function, the terminal apparatus may not transmit information (parameter) indicating whether the terminal apparatus supports the predetermined function. In other words, whether the predetermined function is supported is notified by whether information (parameter) indicating whether the predetermined function is supported is transmitted. Note that the information (parameter) indicating whether the predetermined function is supported may be notified using one bit of 1 or 0.

The higher layer processing unit 102 acquires the DL-SCH from the decoded uplink data (including the CRC) from the receiver 112. The higher layer processing unit 102 performs error detection on the uplink data transmitted by the terminal apparatus. For example, the error detection is performed in the MAC layer.

The controller 104 controls the transmitter 106 and the receiver 112 based on various kinds of configuration information input from the higher layer processing unit 102/receiver 112. The controller 104 generates the downlink control information (DCI) based on the configuration information input from the higher layer processing unit 102/receiver 112, and outputs the generated downlink control information to the transmitter 106. For example, in consideration of the configuration information regarding the DMRS input from the higher layer processing unit 102/receiver 112 (whether the configuration is DMRS structure 1 or DMRS structure 2), the controller 104 configures the frequency allocation of the DMRS (an even subcarrier or an odd subcarrier in the case of DMRS structure 1, and any of the zeroth to the second sets in the case of DMRS structure 2) and generates the DCI.

The controller 104 determines the MCS of the PUSCH in consideration of channel quality information (CSI Measurement result) measured by the channel estimation unit 1122. The controller 104 determines an MCS index corresponding to the MCS of the PUSCH. The controller 104 includes the determined MCS index in the uplink grant.

The transmitter 106 generates the PBCH, the PDCCH, the PDSCH, the downlink reference signal, and the like in accordance with the signal input from the higher layer processing unit 102/controller 104. The coding unit 1060 performs coding (including repetition) using a block code, a convolutional code, a turbo code, a polar coding, an LDPC code, or the like on the BCH, the DL-SCH, and the like input from the higher layer processing unit 102 using a predetermined coding scheme/a coding scheme determined by the higher layer processing unit 102. The coding unit 1060 performs puncturing on the coded bits based on the coding rate input from the controller 104. The modulation unit 1062 performs data modulation on the coded bits input from the coding unit 1060 using a predetermined modulation scheme (modulation order) such as BPSK, QPSK, 16 QAM, 64 QAM, or 256 QAM/a modulation scheme (modulation order) input from the controller 104. The modulation order is based on the MCS index selected by the controller 104.

The downlink control signal generation unit 1064 adds the CRC to the DCI input from the controller 104. The downlink control signal generation unit 1064 encrypts (scrambles) the CRC using the RNTI. Furthermore, the downlink control signal generation unit 1064 performs QPSK modulation on the DCI to which the CRC is added and generates the PDCCH. The downlink reference signal generation unit 1066 generates a sequence known to the terminal apparatus as the downlink reference signal. The known sequence is determined using a predetermined rule based on a physical cell identity for identifying the base station apparatus 10, or the like.

The multiplexing unit 1068 multiplexes the PDCCH/the downlink reference signal/moduiation symbols of the respective channels input from the modulation unit 1062. In other words, the multiplexing unit 1068 maps the PDCCH/the downlink reference signal/modulation symbols of the respective channels to resource elements. The resource elements to which the mapping is performed are controlled using downlink scheduling input from the controller 104. The resource element is the minimum unit of physical resource including one OFDM symbol and one subcarrier. Note that, in a case that MIMO transmission is performed, the transmitter 106 includes as many coding units 1060 and modulation units 1062 as the number of layers. In this case, the higher layer processing unit 102 configures the MCS for each transport block in the corresponding layer.

The radio transmitting unit 1070 performs an inverse Fast Fourier Transform (IFFT) on the multiplexed modulation symbol and the like to generate the OFDM symbol. The radio transmitting unit 1070 adds the cyclic prefix (CP) to the OFDM symbol to generate a baseband digital signal. Furthermore, the radio transmitting unit 1070 converts the digital signal into an analog signal, removes unnecessary frequency component from the analog signal through filtering, performs up-conversion to a carrier frequency, performs power amplification, and outputs the resultant signal to the transmit antenna 108 for transmission.

Following an indication from the controller 104, the receiver 112 detects (demultiplexes, demodulates, and decodes) the signal received from the terminal apparatus 20 through the receive antenna 110, and inputs the decoded data to the higher layer processing unit 102/controller 104. The radio receiving unit 1120 converts the uplink signal received through the receive antenna 110 into a baseband signal by down-conversion, removes unnecessary frequency component from the baseband controls an amplification level such that a signal level is suitably maintained, performs orthogonal demodulation based on an in-phase component and an orthogonal component of the received signal, and converts the orthogonally-demodulated analog signal into a digital signal, The radio receiving unit 1120 removes a part corresponding to the CP from the converted digital signal. The radio receiving unit 1120 performs a Fast Fourier Transform (FFT) on the signal from which the CP has been removed, and extracts a signal of the frequency domain. The signal of the frequency domain is output to the demultiplexing unit 1124.

The demultiplexing unit 1124 demultiplexes the signal input from the radio receiving unit 1120 into signals of the PUSCH, the PUCCH, and the uplink reference signal based on uplink scheduling information (uplink data channel allocation information, and the like) input from the controller 104. The demultiplexed uplink reference signal is input to the channel estimation unit 1122. The demultiplexed PUSCH and PUCCH are output to the equalizing unit 1126.

The channel estimation unit 1122 uses the uplink reference signal to estimate a frequency response (or a delay profile). The result of the frequency response that is channel estimated for demodulation is input to the equalizing unit 1126. The channel estimation unit 1122 measures the uplink channel state (measures the Reference Signal Received Power (RSRP), the Reference Signal Received Quality (RSRQ), and the Received Signal Strength Indicator (RSSI)) using the uplink reference signal. The measurement of the uplink channel state is used to determine the MCS for the PUSCH and the like.

The equalizing unit 1126 performs processing to compensate for the influence of the channel from the frequency response input from the channel estimation unit 1122. As a method for the compensation, any existing channel compensation, such as a method of multiplying an MMSE weight or an MRC weight and a method of applying an MLD, is applicable. The demodulation unit 1128 performs demodulation processing based on the information of a predetermined modulation scheme/the information of a modulation scheme indicated by the controller 104.

The decoding unit 1130 performs decoding processing on the output signal from the demodulation unit based on a predetermined coding rate/the information of a coding rate indicated by the controller 104. The decoding unit 1130 inputs the decoded data (such as the UL-SCH) to the higher layer processing unit 102.

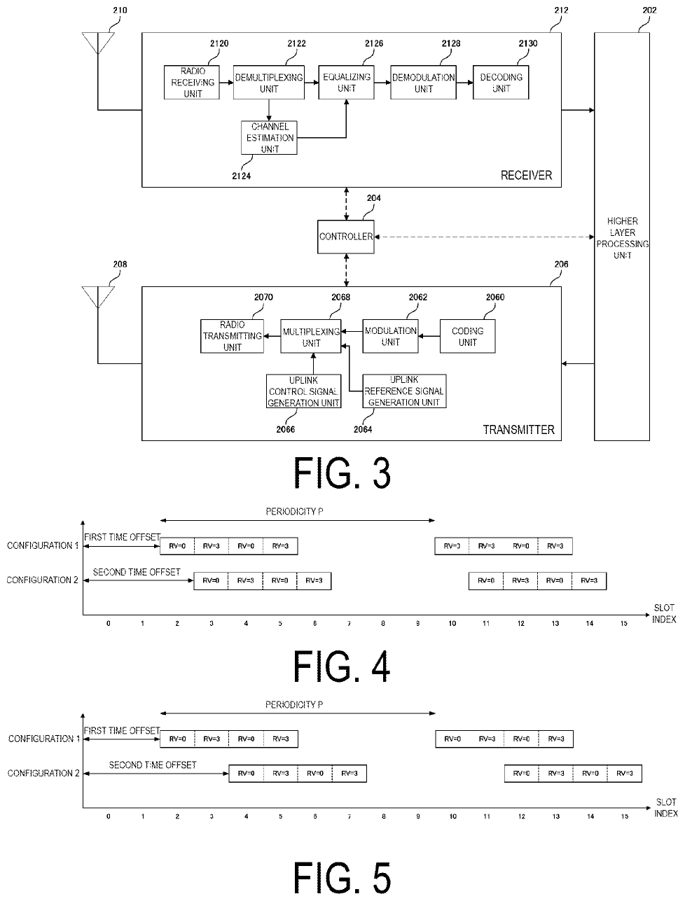

FIG. 3 is a schematic block diagram illustrating a configuration of the terminal apparatus 20 according to the present embodiment. The terminal apparatus 20 includes a higher layer processing unit (higher layer processing step) 202, a controller (control step) 204, a transmitter (transmitting step) 206, a transmit antenna 208, a receive antenna 210, and a receiver (receiving step) 212.

The higher layer processing unit 202 performs processing of a medium access control (MAC) layer, a packet data convergence protocol (PDCP) layer, a radio link control (RLC) layer, and a radio resource control (RRC) layer. The higher layer processing unit 202 manages various kinds of configuration information of the terminal apparatus itself. The higher layer processing unit 202 notifies the base station apparatus 10 of information indicating functions of the terminal apparatus supported by the terminal apparatus itself (UP Capability) via the transmitter 206. The higher layer processing unit 202 notifies the base station apparatus of the UE Capability using RRC signaling.

The higher layer processing unit 202 acquires decoded data such as a DL-SCH and a BCH from the receiver 212. The higher layer processing unit 202 generates a HARQ-ACK from a result of error detection of the DL-SCH. The higher layer processing unit 202 generates an SR. The higher layer processing unit 202 generates a UCI including the HARQ-ACK/the SR/a CSI (including a CQI report). In addition, in a case that DMRS structure information is notified by the higher layer, the higher layer processing unit 202 inputs the DMRS structure information to the controller 204. The higher layer processing unit 202 inputs the UCI and the UL-SCH to the transmitter 206. Note that the controller 204 may include some of functions of the higher layer processing unit 202.

The controller 204 interprets downlink control information (DCI) received via the receiver 212. The controller 204 controls the transmitter 206 in accordance with PUSCH scheduling/an MCS index/Transmission Power Control (TPC), and the like acquired from the DCI for uplink transmission. The controller 204 controls the receiver 212 in accordance with PDSCH scheduling/an MCS index and the like acquired from the DCI for downlink transmission. Furthermore, the controller 204 specifies frequency allocation of the DMRS according to the information on the frequency allocation of the DMRS included in the DCI for downlink transmission and the DMRS structure information input from the higher layer processing unit 202.

The transmitter 206 includes a coding unit (coding step) 2060, a modulation unit (modulation step) 2062, an uplink reference signal generation unit. (uplink reference signal generation step) 2064, an uplink control signal generation unit (uplink control signal generation step) 2066, a multiplexing unit (multiplexing step) 2068, and a radio transmitting unit (radio transmitting step) 2070.

Under control of the controller 204 (in accordance with a coding rate calculated based on the MCS index), the coding unit 2060 codes the uplink data (UL-SCH) input from the higher layer processing unit 202 through convolutional coding, block coding, turbo coding, or the like.

The modulation unit 2062 modulates the coded bits input from the coding unit 2060 (generates modulation symbols for the PUSCH) with a modulation scheme indicated by the controller 204 such as BPSK, QPSK, 16 QAM, 64 QAM, and 256 QAM/a modulation scheme predetermined for each channel.

The uplink reference signal generation unit 2064 generates a sequence determined complying with a predetermined rule (formula) based on a physical cell identity (PCI, which is also referred to as a cell ID, or the like) for identifying the base station apparatus 10, a bandwidth in which uplink reference signals are mapped, a cyclic shift, parameter values to generate a DMRS sequence, further the frequency allocation, and the like, following an indication of the controller 204.

Following the indication of the controller 204, the uplink control signal generation unit 2066 codes the UCI, performs BPSK/QPSK modulation, and generates modulation symbols for the PUCCH.

In accordance with the uplink scheduling information from the controller 204 (a transmission interval in Configured Scheduling (CS) for uplink included in an RRC message, frequency domain and time domain resource allocation included in the DCI, and the like), the multiplexing unit 2068 multiplexes the modulation symbols for the PUSCH, the modulation symbols for the PUCCH, and the uplink reference signals for each transmit antenna port (a DMRS port) (in other words, respective signals are mapped to resource elements).

Here, configured scheduling (CS or configured grant scheduling) will be described. There are two types of transmission without dynamic grant. One is configured grant type 1 given through the RRC and stored as configured grant, and the other one is configured grant type 2 given through the PDCCH and stored and cleared as configured grant based on L1 signaling indicating configured grant activation or configured grant deactivation. Type 1 and type 2 are configured in RRC for each serving cell and each BWP. A plurality of configurations can be active simultaneously only in different serving cells. For type 2, activation and deactivation are independent between serving cells. For the same serving cell, an MAC entity is configured for either type 1 or type 2. In a case that type 1 is configured, the RRC configures the following parameters.
cs-RNTI for re-transmission
periodicity: periodicity of configured grant type 1
timeDomainOffset: Offsets of resources regarding SFN=0 in the time domain
timeDomainAllocation: allocation of configured grant in the time domain including the parameter startSymbolAndLength
nrofHARQ-Processes: the number of HARQ processes

In addition, in a case that type 2 is configured, the RRC configures the following parameters.
cs-RNTI: CS-RNTI for activation, deactivation, and re-transmission
periodicity: periodicity of configured grant type 2
nrofHARQ-Processes: the number of HARQ processes

That is, ConfiguredGrantConfig is used to configure uplink transmission without dynamic grant in accordance with two schemes. Actual uplink grant is configured via the RRC in Configured Grant type 1, and is given via the PDCCH processed with CS-RNTI in Configured Grant type 2.

A parameter repK configured by the higher layer defines the number of repetitions to be applied to transmitted transport blocks. repK-RV indicates a redundancy version pattern to be applied to a repetition. Regarding an n-th transmission opportunity out of repeated K times, transmission associated with the value in (mod (n−1, 4)+1)-th order in a configured RV sequence (redundancy version pattern) is performed. In addition, the initial transmission of one transport block is started in the first transmission opportunity out of repeated K times in a case that the configured RV sequence is {0, 2, 3, 1}. In a case that the configured RV sequence is {0, 3, 0, 3}, the initial transmission is started in any transmission opportunity associated with RV=0 out of repeated K times. In a case that the configured RV sequence is {0, 0, 0, 0}, the initial transmission is started in any transmission opportunity out of repeated K times, except for the last transmission opportunity at the time of K=8. In any RV sequence, the repetition is terminated after K times of repetitive transmission, or at the earlier time between the last transmission opportunity out of repeated K times in a periodicity P or in a case that the uplink grant for scheduling the same transport block in the periodicity P is received. The terminal apparatus does not expect to be configured a time period regarding the transmission repeated K times that is longer than the time period calculated by the periodicity P. For both type 1 PUSCH transmission and type 2 PUSCH transmission using the configured grant, the terminal apparatus repeats the transport block over the continuous repK slots in a case that the terminal apparatus is configured to repK>1. At this time, the terminal apparatus applies the same symbol allocation to each slot. In a case that the procedure of the terminal apparatus regarding determination of the slot structure judges (determines) the symbol of an allocated slot as a downlink symbol, transmission in the slot is omitted for PUSCH transmission of a plurality of slots. In a case that the repK is configured, any value of one, two, four, and eight times can be configured as a value. However, in a case that an RRC parameter itself is not present, transmission is performed in the number of repetitions being 1. In addition, the repK-RV can be configured to any of {0, 2, 3, 1}, {0, 3, 0, 3}, and {0, 0, 0, 0}. Note that, although different redundancy version signals generated from the same transport block are signals including the same transport block (information bit sequence), but at least some of the including coded bits are different.

In a case that the configured RV sequence is {0, 0, 0, 0}, the initial transmission is started in any transmission opportunity out of repeated K times, except for the last transmission opportunity at the time of K=8. In this case, eight times of repetition are not satisfied except a case that transmission is started from an opportunity other than the first transmission opportunity. Thus, the 3GPP has proposed to configure a plurality of time offsets. FIG. 4 illustrates the slot structure in a case that the RV sequence to be configured is {0, 3, 0, 3} and a plurality of time offsets are configured. Although a case that configuration 1 and configuration 2 are configured, it is not limited thereto, and three or more configurations may be configured. The horizontal axis indicates a slot index. Although the case in which the slot is used as a reference has been described in FIG. 4, the reference may be anything as long as it is a section including a plurality of OFDM symbols, such as a mini-slot. FIG. 4 illustrates a case that a periodicity is eight slots and the number of repetitions is four. In the case that only the configuration 1 is present, transmission can be started from the slot indexes 2, 4, 10, and 12. On the other hand, in a case that the configuration 2 is provided in addition to the configuration 1, transmission from slot indexes 3, 5, 11, and 13 can be started in addition to the slot index described above. However, although, in the case of the configuration 1 alone, the receiver of the base station apparatus is only required to perform processing to determine whether there is transmission from the terminal apparatus that has configured the configuration only in the slot indexes 2, 4, 10, and 12, in a case that the configuration 1 and the configuration 2 are present, there is need to perform the processing to determine whether there is transmission from the terminal apparatus in the slot indexes 2 to 5 and 10 to 13, and thus the circuit scale of the base station apparatus becomes enormous. Thus, as illustrated in FIG. 5, by configuring a first time offset and a second time offset such that the redundancy version in each slot matches in the configuration 1 and the configuration 2, the amount of signal processing for signal (user) detection can be greatly suppressed, For example, as compared to FIG. 4, signal processing for signal detection can be avoided in slot indexes 3, 5, 11, and 13 in FIG. 5. Note that the higher layer processing unit or the controller of the base station apparatus may make slots with RV=0 match in the configuration I and the configuration 2, or may make the difference between the time offsets to be an even number (a multiple of two) in a case that an RV sequence is {0, 3, 0, 3}.

Next, a case in which a configured RV sequence is other than {0, 0, 0, 0} will be described. In a case that a configured RV sequence is {0, 0, 0, 0}, transmission can be started in any slot under repetition (except for transmission from the last transmission opportunity in a case that 8 is configured as the number of repetitions), there is no limit on the value of a time offset, Alternatively, in the case that RV sequence is {0, 0, 0, 0}, the difference in time offsets may be a multiple of 1.

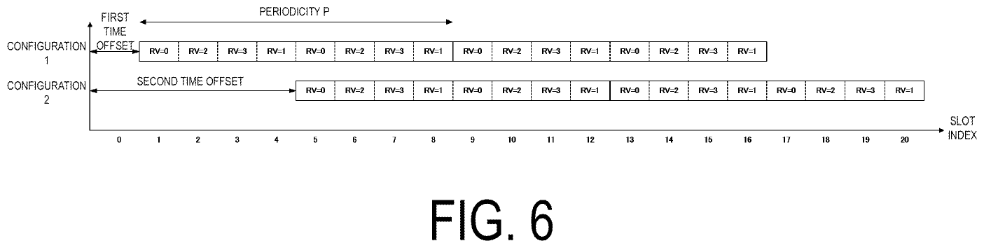

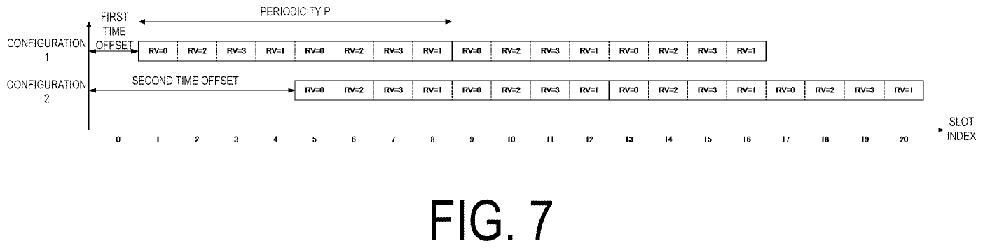

Next, a case in which a configured RV sequence is {0, 2, 3, 1} will be described, In the case that a configured RV sequence is {0, 2, 3, 1}, transmission can be started only in the leading slot under repetition, and thus the time offset is limited such that the transmission slot is not shared with the repeated transmission of another configuration as illustrated in FIG. 6. Alternatively, in the case that an RV sequence is {0, 2, 3, 1}, a time offset may be given such that the slots with RV=0 matches in a plurality of configurations as illustrated in FIG. 7. In other words, the higher layer processing unit or the controller of the base station apparatus may perform control such that the difference between time offsets is a multiple of 4.

Next, a configuration method for a time offset will be described. In a case that the RRC signaling is configured as in configured grant type 1, values of time offsets may be notified to the terminal apparatus from the base station apparatus as a plurality of RRC parameters, or second and subsequent time offsets may be given according to the RV sequence and the number of configurations. For example, in a case that an RV sequence is {0, 3, 0, 3} and the number of configurations is 2, a value obtained by shifting the time offset of the configuration 1 by 2 is configured to a time offset of the configuration 2, or in a case that an RV sequence is {0, 0, 0, 0} and the number of configurations is 2, a value obtained by shifting the time offset of the configuration 1 by 1 is configured to a time offset of the configuration 2.

In a case that a time offset is given such that the slots with RV=0 match in a plurality of configurations, the terminal apparatus performs transmission in any one of the plurality of configurations. The controller of the terminal apparatus determines which of the plurality of configurations is used for transmission. However, in a case that the RRC signaling is performed by the higher layer processing units of the terminal apparatus and the base station apparatus and a higher layer parameter such as the RRC for priority is configured, transmission may be configured according to the higher layer parameter. Alternatively, priorities may be specified in advance among the configurations and the controller of the terminal apparatus may perform transmission in accordance with the specified priorities.

The reason for matching RV of the configuration 1 with RV of the configuration 2 in a certain slot as described above is to reduce the processing of the base station apparatus. However, in a case that the scrambling operations for the DMRS and the data are different, signals generated for each configuration are different, and as a result, an amount of calculation at the receiver of the base station apparatus increases because the base station apparatus processes a plurality of signals as transmission candidates. Thus, in the slots with RV=0 in a plurality of configurations, the same DMRS needs to be transmitted and scrambling operation for the data needs to be common. Thus, in a case that there are a plurality of configurations, the DMRS is generated according to the criteria of the configuration 1 (notification using the DCI or the allocated slot index) and the scrambling operation is applied according to the criteria of the configuration 1 (notification using the DCI or the allocated slot index). This makes it possible to transmit the same signal in the same slot between the configurations, so the amount of calculation required for user detection at the receiver of the base station apparatus can be greatly reduced.

By sharing the same scrambling operation for the DMRS and the data among the plurality of configurations as described above, the amount of calculation required for user detection can be greatly reduced. On the other hand, in a case that the same scrambling operation for the DMRS and the data is shared among the plurality of configurations, the receiver of the base station apparatus is unable to grasp which configuration the controller of the terminal apparatus has selected. Thus, to determine which configuration is used for transmission, the DMRS sequence is changed for each configuration. As a result, it is possible to grasp, by the received DMRS sequence, which configuration has been used for transmission. Note that, differentiation such as scrambling operation may be performed to grasp which configuration has been used for transmission, instead of the DMRS. Furthermore, by varying the plurality of parameters (the plurality of signals), it is possible to grasp which configuration has been used for transmission has been performed. In addition, whether the DMRS or other signals (parameters) are shared or varied among the configurations as described above may be changed depending on the higher layer parameter such as the RRC parameter.

In a case that a higher layer parameter (frequencyHopping) regarding the frequency hopping is configured, a value of the configuration can be configured to mode 1 or mode 2. Mode 2 is a mode for inter-slot hopping in which transmission is performed by changing the frequency for each slot in a case that transmission is performed using a plurality of slots. On the other hand, mode 1 is a mode for intra-slot hopping in which the slot is divided into a first half and a second half and transmission is performed by changing the frequency in the first half of the slot and the second half of the slot in a case that transmission is performed using one or a plurality of slots. As frequency allocation in the frequency hopping, the radio resource allocation in the frequency domain notified using the DCI or RRC is applied to a first hop, and in the frequency allocation of a second hop, a radio resource obtained by shifting the radio resource used in the first hop by the value configured by a higher layer parameter (frequencyHoppingOffset) regarding the amount of the frequency hopping is allocated.

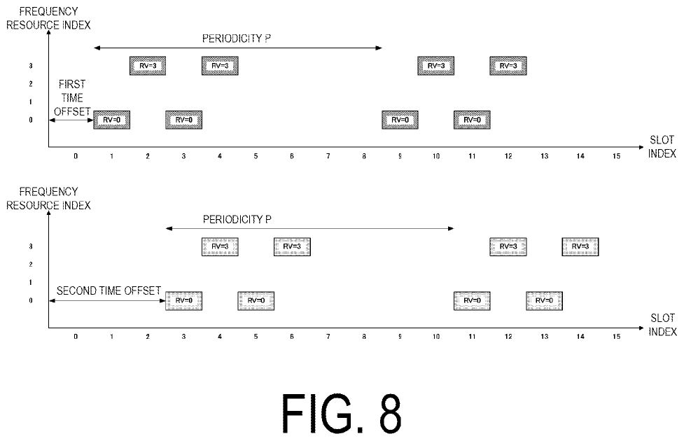

The same applies in a case that frequency hopping is applied and a plurality of configurations are further made for the configured grant. An example of the application of slot hopping is illustrated in FIG. 8. As illustrated in FIG. 8, time offsets are configured such that the hop of each configuration has the same slot, the same frequency resource, and the same RV. This makes it possible to significantly reduce an amount of calculation for user detection by the base station apparatus.

The radio transmitting unit 2070 performs an Inverse Fast Fourier Transform (IFFT) on the multiplexed signal to generate the OFDM symbol. The radio transmitting unit 2070 adds the CP to the OFDM symbol to generate a baseband digital signal. Furthermore, the radio transmitting unit 2070 converts the baseband digital signal into an analog signal, removes unnecessary frequency component from the analog signal, converts the signal into a signal of a carrier frequency by up-conversion, performs power amplification, and transmits the resultant signal to the base station apparatus 10 via the transmit antenna 208.

The receiver 212 includes the radio receiving unit (radio receiving step) 2120, the demultiplexing unit (demultiplexing step) 2122, a channel estimation unit (channel estimation step) 2144, an equalizing unit (equalizing step) 2126, a demodulation unit (demodulation step) 2128, and a decoding unit (decoding step) 2130.

The radio receiving unit 2120 converts a downlink signal received through the receive antenna 210 into a baseband signal by down-conversion, removes unnecessary frequency component from the baseband signal, controls an amplification level such that a signal level is suitably maintained, performs orthogonal demodulation based on an in-phase component and an orthogonal component of the received signal, and converts the orthogonally-demodulated analog signal into a digital signal. The radio receiving unit 2120 removes a part corresponding to the CP from the converted digital signal, performs an FFT on the signal from which the CP has been removed, and extracts a signal of the frequency domain.

The demultiplexing unit 2122 demultiplexer the extracted signal of the frequency domain into the downlink reference signal, the PDCCH, the PDSCH, and the PBCH. The channel estimation unit 2124 uses the downlink reference signal (such as the DM-RS) to estimate the frequency response (or the delay profile). The result of the frequency response that is channel estimated for demodulation is input to the equalizing unit 1126. The channel estimation unit 2124 measures an uplink channel state (measures the Reference Signal Received Power (RSRP), the Reference Signal Received Quality (RSRQ), the Received Signal Strength Indicator (RSSI), and the Signal to Interference plus Noise power Ratio (SINR)) using the downlink reference signal (such as the CSI-RS). The measurement of the downlink channel state is used to determine the MCS for the PUSCH and the like. The measurement result of the downlink channel state is used to determine the CQI index and the like.

The equalizing unit 2126 generates an equalization weight based on an MMSE rule using the frequency response input from the channel estimation unit 2124. The equalizing unit 2126 multiplies the signal (the PUCCH, the PDSCFI, the PBCH, or the like) input from the demultiplexing unit 2122 by the equalization weight. The demodulation unit 2128 performs demodulation processing based on the information of a predetermined modulation order/the information of a modulation order indicated by the controller 204.

The decoding unit 2130 performs decoding processing on the signal output front the demodulation unit 2128 based on the information of a predetermined coding rate/the information of a coding rate indicated by the controller 204. The decoding unit 2130 inputs the decoded data (such as the DL-SCH) to the higher layer processing unit 202.

A program that operates on an apparatus according to the present invention may serve as a program that controls a Central Processing Unit (CPU) and the like to cause a computer to operate in such a manner as to implement the functions of the above-described embodiment according to the present invention. A program or the information handled by the program is temporarily loaded into a volatile memory such as a Random Access Memory (RAM) at the time of processing, or is stored in a non-volatile memory such as a flash memory, or a Hard Disk Drive (HDD), and then is read, modified, and written by the CPU as necessary.

Note that the apparatuses in the above-described embodiments may be partially implemented by a computer. In that case, a program for implementing the functions of the embodiments may be recorded on a computer readable recording medium. It may be implemented by causing a computer system to read and execute the program recorded on this recording medium. It is assumed that the “computer system” refers to a computer system built into the apparatuses and the computer system includes an operating system and hardware such as a peripheral device. Furthermore, the “computer readable recording medium” may be any of a semiconductor recording medium, an optical recording medium, a magnetic recording medium, and the like.

Moreover, the “computer readable recording medium” may include a medium that dynamically retains a program for a short period of time, such as a communication wire that is used for transmission of the program over a network such as the Internet or over a communication line such as a telephone line, and may also include a medium that retains a program for a certain period of time, such as a volatile memory within the computer system serving as a server or a client in a case that the program is transmitted via the communication wire. Furthermore, the above-described program may be one for implementing part of the above-described functions, and also may be one capable of implementing the above-described functions in combination with a program already recorded in the computer system.

Furthermore, each functional block or various characteristics of the apparatuses used in the above-described embodiments can be implemented or performed with an electric circuit, that is, typically an integrated circuit or a plurality of integrated circuits. An electric circuit designed to perform the functions described in the present specification may include a general purpose processor, a digital signal processor (DSP), an application specific integrated circuit (ASIC), a field programmable gate array (FPGA), or another programmable logic device, a discrete gate or transistor logic, a discrete hardware component, or a combination thereof. The general purpose processor may be a microprocessor or may be a processor, a controller, a micro-controller, or a state machine of a known type. The above-mentioned electric circuit may include a digital circuit, or may include an analog circuit. Furthermore, in a case that a technology for an integrated circuit that replaces the existing integrated circuits appears as the semiconductor technology advances, it is also possible to use such an integrated circuit of the technology.

Note that the invention of the present application is not limited to the above-described embodiments. Although the apparatuses have been described as examples in the embodiment, the invention of the present application is not limited to these apparatuses, and is applicable to a stationary type or non-movable type electronic device installed indoors or outdoors, such as a terminal apparatus or a communication apparatus, for example, an AV device, a kitchen device, a cleaning or washing device, an air-conditioning device, an office device, a vending machine, and other household appliances.

Although the embodiments of the present invention have been described in detail with reference to the drawings, a specific configuration is not limited to the embodiments, and change in design and the like made within the scope not departing from the gist of the present invention is also included. Furthermore, various modifications are possible within the scope of claims, and embodiments that are made by suitably combining technical means disclosed according to the different embodiments are also included in the technical scope of the present invention. Furthermore, a configuration in which elements described in each embodiment that exhibit similar effects are substituted for one another is also included.

### INDUSTRIAL APPLICABILITY

The present invention can be preferably used for a base station apparatus, a terminal apparatus, and a communication method.

1. A base station apparatus for communicating with a terminal apparatus by using configured grant scheduling, the base station apparatus comprising:
a controller configured to configure values of a plurality of time offsets for the configured grant scheduling; and
a higher layer processing unit configured to, for the configured grant scheduling, configure a redundancy version pattern and configure the number of repetitions of the redundancy version pattern to a value greater than one, wherein
the controller configures the values of the plurality of time offsets based on the redundancy version pattern.

2. The base station apparatus according to claim 1, wherein
in a case that the controller is allowed to perform transmission using a plurality of transmission methods in a predetermined slot through the plurality of time offsets, the controller performs configuration to use an identical redundancy version in the predetermined slot.

3. The base station apparatus according to claim 2, wherein
the controller performs configuration such that demodulation reference signal sequences are different, in the predetermined slot, through the plurality of time offsets.

4. The base station apparatus according to claim 2, wherein
the controller performs configuration such that scrambling operations are different, in the predetermined slot, through the plurality of time offsets.

5. A terminal apparatus for communicating with a base station apparatus by using configured grant scheduling, the terminal apparatus comprising:
a controller configured to configure values of a plurality of time offsets for the configured grant scheduling; and
a higher layer processing unit configured to configure a redundancy version pattern of the configured grant scheduling and configure the number of repetitions to a value greater than one,
wherein the controller configures the values of the plurality of time offsets based on the redundancy version pattern.
